(19) United States
(12) Patent Application Publication
(10) Pub. No.: US 2025/0286623 A1
(43) Pub. Date: Sep. 11, 2025

(54) DYNAMIC SEGMENTED DFOS OPERATION ON BIDIRECTIONAL WDM MULTI-SPAN FIBER LINKS USING FIBER NETWORK ROADMs

(71) Applicant: NEC Laboratories America, Inc., Princeton, NJ (US)

(72) Inventors: Yue-Kai HUANG, Princeton, NJ (US); Ming-Fang HUANG, Princeton, NJ (US); Ezra IP, West Windsor, NJ (US); Junqiang HU, Davis, CA (US)

(73) Assignee: NEC Laboratories America, Inc., Princeton, NJ (US)

(21) Appl. No.: 19/072,968

(22) Filed: Mar. 6, 2025

Related U.S. Application Data
(60) Provisional application No. 63/561,871, filed on Mar. 6, 2024.

(51) Int. Cl. H04B 10/25; H04J 14/02

(52) U.S. Cl. CPC H04B 10/2589; H04J 14/0202; H04J 14/0227

(57) ABSTRACT

Dynamic segmented DFOS systems and methods operating on bidirectional wavelength division multiplexed (WDM), multi-span optical fiber links using network reconfigurable optical add-drop multiplexers (ROADMs). A distributed sensing interface module (DSIM) is inserted at existing network switching nodes which utilize ROADMs. Operationally, DFOS probe signals occupy one of WDM channel which is switched by the ROADMs in a bidirectional fiber network. The DSIM collects backscattered/reflected sensing signals in one direction, and routes them to an add port of the ROADM in the other direction for conveyance to a DFOS interrogator—after optical filtering and amplification.

### CROSS REFERENCE TO RELATED APPLICATIONS

This application claims the benefit of U.S. Provisional Patent Application Ser. No. 63/561,871 filed Mar. 6, 2024, the entire contents of which is incorporated by reference as if set forth at length herein.

### FIELD OF THE INVENTION

This application relates generally to distributed fiber optic sensing (DFOS) systems and methods. More particularly, it pertains to systems and methods that extend DFOS operation over multi-span telecommunications optical fiber links while mitigating optical signal-to-noise ratio (OSNR) deterioration.

### BACKGROUND OF THE INVENTION

As will be understood by those skilled in the art, distributed fiber optic sensing (DFOS) employs backward scattering mechanisms in optical fibers, such as Rayleigh, Brillouin, and Raman scattering, to sense environmental conditions around the optical fibers that may be part of larger, telecommunications cables. Efforts to expand the operation of DFOS systems over multiple spans of optical fibers has proven to be challenging because optical signal-to-noise ratio (OSNR) deteriorates as asynchronous spontaneous emission (ASE) noise from optical amplifiers accumulates. Moreover, inline amplifiers employed for fiber networks only allow for one-way signal propagation, due to the presence of isolators in erbium-doped fiber amplifiers (EDFAs).

To solve this issue, some previous designs have been proposed to provide multi-span DFOS operation, either using a same fiber or another fiber to route the DFOS backscatter signal in the opposite direction to the interrogator. However, these approaches either require a network to adopt a new amplification scheme, like Raman amplification, or to install complex wavelength switching components dedicated to DFOS signals.

### SUMMARY OF THE INVENTION

An advance in the art is made according to aspects of the present disclosure directed to dynamic segmented DFOS systems and methods operating on bidirectional wavelength division multiplexed (WDM), multi-span optical fiber links using network reconfigurable optical add-drop multiplexers (ROADMs).

In sharp contrast to the art, instead of replacing inline amplifiers and/or installing dedicated wavelength switching components for DFOS operation, systems and methods according to aspects of the present disclosure insert a distributed sensing interface module (DSIM) at the existing network switching nodes which utilize reconfigurable optical add/drop multiplexers (ROADMs).

Operationally, DFOS probe (interrogation/sensing) signals occupy one of WDM channel which is switched by the ROADMs in a bidirectional fiber network. The DSIM collects backscattered/reflected sensing signals in one direction, and routes them to an add port of the ROADM in the other direction for conveyance to a DFOS interrogator-after optical filtering and amplification.

By controlling both ROADM and DSIM at each node, interrogation/sensing signals from each fiber span between ROADM nodes can be relayed back to the interrogator in a cascaded fashion.

Additionally, it is possible to set ROADM and DSIM to operate in a segmented manner, such that only a desired portion of overall length of the optical fiber is monitored. In this inventive manner, signal sampling rate is kept higher than in the art and is unbounded by total length of an optical fiber link.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative DFOS operation in bidirectional WDM fiber networks using bidirectional ROADMs and inserted DSIMs for sensing signa routing and conditioning according to aspects of the present disclosure.

FIG. 3 is a schematic diagram showing illustrative details of a distributed sensing interface module (DSIM) which is inserted at each ROADM node for DFOS overlay operation on bidirectional WDM networks according to aspects of the present disclosure.

FIG. 4 is a schematic diagram showing an illustrative ROADM and DSIM confirmation for monitoring entire optical links in which Drop DEMUX WSS set to drop DFOS channel, ADD MUX WSS set to add DFOS channel, ON DSIM EDFA turned on, according to aspects of the present invention.

FIG. 5 are schematic diagrams showing illustrative ROADM and DSIM configurations for monitoring single fiber spans in which Thru: DFOS channel is passed between Mux/Demux WSSs as express through channel, Off: DSIM EDFA turned off, according to aspects of the present disclosure.

FIG. 6 is a schematic diagram showing illustrative ROADM and DSIM configuration for monitoring segments containing multiple spans according to aspects of the present invention.

FIG. 7 is a schematic diagram showing illustrative DFOS sampling adjustment for monitoring the fiber segments with shorter fiber lengths according to aspects of the present disclosure.

FIG. 8 is a block diagram showing illustrative features of systems and methods according to aspects of the present disclosure.

FIG. 9 is a schematic diagram showing an illustrative computer system in which methods of the instant disclosure may be executed.

FIG. 10 is a schematic diagram showing an illustrative experimental arrangement for systems and methods according to aspects of the present disclosure.

FIG. 11 is a schematic diagram showing an illustrative experimental segment sensing scheme with WDM switching module according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

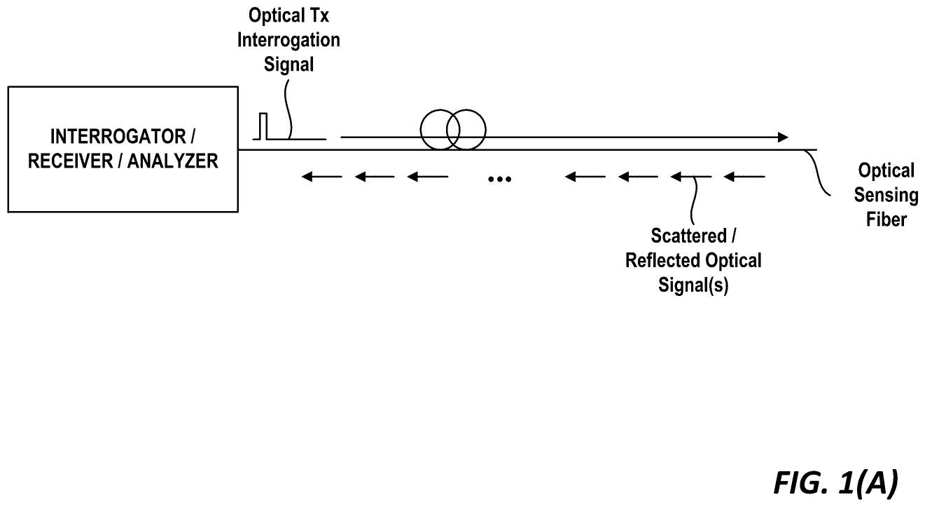

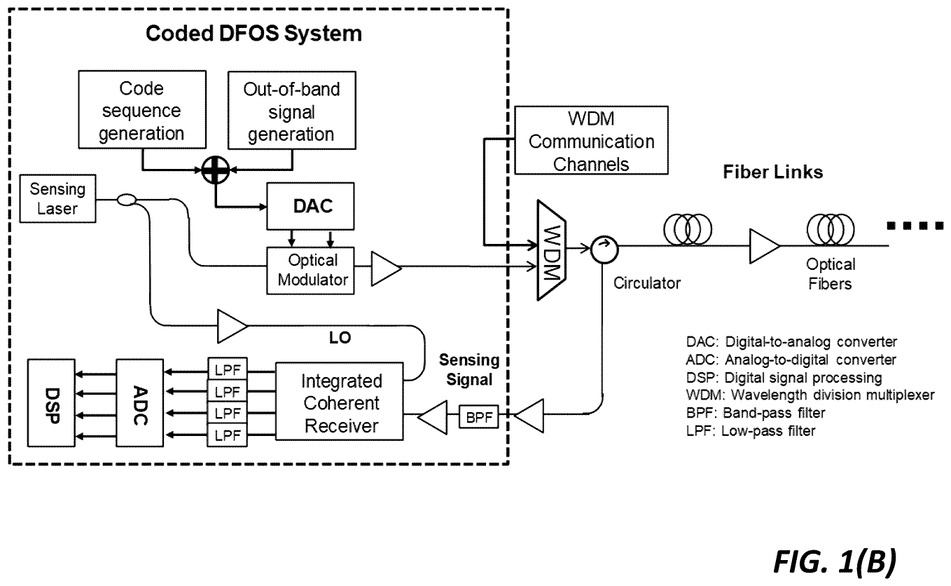

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

As noted, rainfall detection and rainfall intensity monitoring are crucial functions for a wide range of societal, scientific, and industrial applications and/or functions, such as transportation, agriculture, water management, weather forecasting, and building energy estimation. Currently, the collection of rainfall intensity data primarily uses land-based weather stations and Earth orbiting satellites. However, these methods are subject to limitations in terms of availability and accessibility.

As climate change leads to more frequent and intense extreme precipitation events, there is an urgent need for improved methods to measure rainfall intensity accurately. This urgency highlights the imperative to innovate and develop sensors that are capable of long-range, wide-coverage rain data collection, thereby enhancing our ability to respond to and manage the impacts of these changes effectively. As we shall show and describe, the present disclosure describes innovative systems, methods, and structures that solve the rain intensity monitoring problem noted by learning from raw fiber sensing data in the frequency domain.

According to aspects of the present disclosure, we introduce an innovative Distributed Fiber Optic Sensing (DFOS) technology that advantageously utilizes existing telecommunications infrastructure networks. DFOS enables a novel approach to monitor weather conditions and environmental changes, provides real-time, continuous, and precise measurements over large areas and delivers comprehensive insights beyond the visible spectrum. To illustrate our inventive techniques, we explore rain intensity monitoring as an illustrative example for demonstrating the sensing capabilities of our DFOS system.

To enhance the rain sensing performance, we introduce a Deep Phase-Magnitude Network (DFMN), divide raw sensing data into phase and magnitude components, thereby allowing targeted feature learning on each component independently. Furthermore, we introduce a Phase Frequency learnable filter (PFLF) for the phase component filtering and conduct standard convolution layers on the magnitude component, leveraging the inherent physical properties of optical fiber sensing. We formulate the phase-magnitude channel into a parallel network and subsequently fuse the features for a comprehensive analysis in the end. Experimental results on the collected fiber sensing data show that the proposed method performs favorably against the state-of-the-art approaches

We describe a fiber sensing solution and demonstrate rain intensity monitoring as an illustrative example to demonstrate its environmental capabilities. We introduce a Deep Phase-Magnitude Network (DPMN) to separate the raw data into phase and magnitude components, enabling targeted, fine-grained feature learning on each component independently.

According to aspects of the present disclosure, we describe a Phase Frequency Learnable Filter (PFLF) dedicated to filtering a phase component. The PFLF incorporates learnable filters to estimate the scaled dot-product attention of phase and magnitude. Our analysis and experimental results demonstrate that the PFLF module achieves superior performance with lower time complexity.

Finally, we demonstrate that exploring the physical properties of fiber sensing data and analyzing DFOS data in the frequency domain enhances the accuracy of rain monitoring. Our approach shows favorable performance against state-of-the-art methods, indicating its effectiveness and potential for broader environmental sensing applications

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

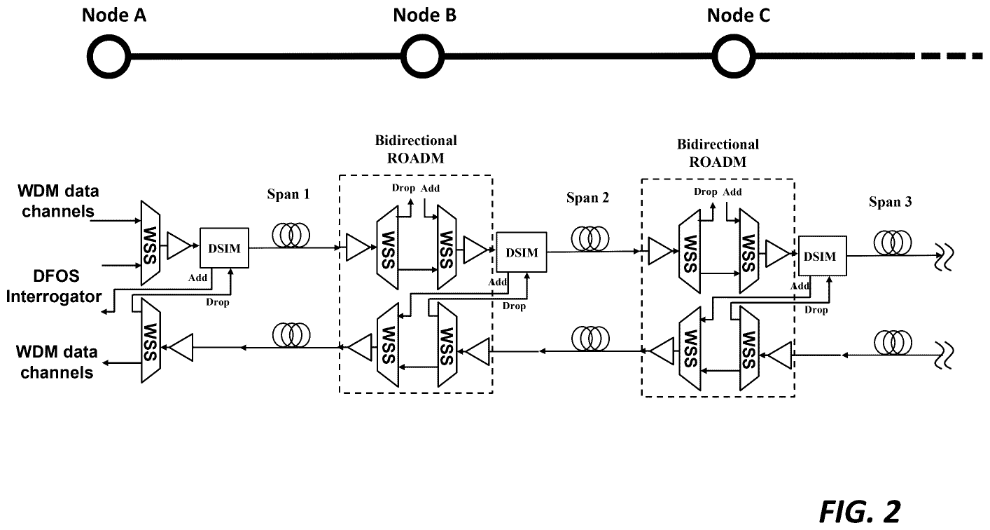

FIG. 2 is a schematic diagram showing illustrative DFOS operation in bidirectional WDM fiber networks using bidirectional ROADMs and inserted DSIMs for sensing signa routing and conditioning according to aspects of the present disclosure.

The structure shown in the figure illustrates how our inventive scheme/arrangement operates. As may be observed, our scheme is overlayed on a typical bidirectional WDM optical network using 1 fiber pair. The WDM fiber link has multiple fiber spans connected using ROADM nodes.

As those skilled in the art will readily understand and appreciate, the ROADM for a WDM fiber network is typically designed with—for each direction—a pre-amplifier followed by a wavelength selective switch (WSS) for dropping channels, another WSS for adding channels, and a booster amplifier. According to an aspect of the present disclosure, A DFOS interrogator is located at an initial node (Node A), and its interrogation signal is added as one WDM channel travelling—in this illustrative embodiment—west-to-east. For every fiber span, a distributed sensing interface module (DSIM) is positioned at the output of the ROADM booster in a west-to-east direction. The DSIM is used to collect reflected sensing signals from the optical fiber span that it is directly connected to. By accessing the WSS add and drop ports at the east-to-west direction of the ROADM, the DSIM combines reflected sensing signals from different spans and routes them back to the DFOS interrogator

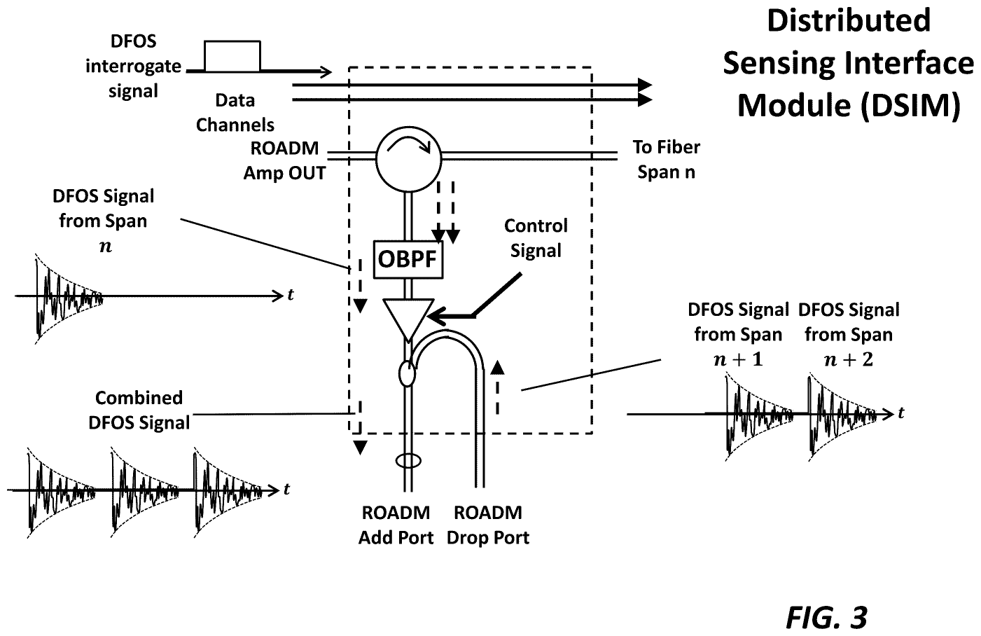

FIG. 3 is a schematic diagram showing illustrative details of a distributed sensing interface module (DSIM) which is inserted at each ROADM node for DFOS overlay operation on bidirectional WDM networks according to aspects of the present disclosure.

As noted, the DSIM is inserted at each ROADM node. Major components of the DSIM include an optical circulator, an optical bandpass filter (OBPF), an optical amplifier, and an optical coupler.

Two ports of the circulator are connected to the ROADM amplifier output and the optical fiber span (west-to-east direction) and collect reflected signals from the optical fiber and drop them at the third port. The reflected signal(s) include both DFOS sensing signal(s) as well as data channel reflections, which can advantageously be filtered out by the OBPF. The sensing signal for this fiber span is amplified by an optical amplifier, i.e. EDFA, to a similar power level as the transmitted data channels, before being multiplexed back to the WDM traffic going east-to-west using the ROADM add port. If there are DFOS signals from subsequent fiber spans (further away from interrogator) wished to be monitored, they can be dropped at the ROADM drop port and combined with the signal from current span through the effect of an optical coupler.

With reference to the inset of FIG. 3, one may observe that DFOS signal(s) from different spans do not interfere with one other due to the time-of-flight differences. As the DFOS signals from different spans combine, the starting edges of current span n and next span n+1 are offset by 2Tₙ=2×Lₙ·n_{eff}/c, where Lₙ is the length of fiber span n. It takes Tₙ for the DFOS interrogation signal to reach span n+1, and Tₙ for the reflected signal(s) from span n+1 to travel back to the DSIM at span n. As the total duration of the DFOS signal from span n is also 2Tₙ, the signals from two adjacent spans will not interfere with each other, and the same can be proved for all fiber spans.

As presently contemplated, all the components in the DSIM are passive except for the optical amplifier, which is needed for OSNR preservation and power level adjustment for the DFOS signal.

Those skilled in the art will understand and appreciate that a control signal may be used to turn the optical amplifier on and off, which can be used to dynamically select the fiber span for DFOS monitoring, if an operator chooses not to use ROADM for this operation. The detailed steps for how to perform the dynamic segmented DFOS monitoring using ROADM and DSIM control will be explained later in this disclosure.

Note that even though the description in this disclosure only shows multiplexing DFOS interrogation signal with west-east data traffic and collecting the reflected signal in the east-west direction, the operation can be done reciprocally for the other direction by applying the proper connections. It can also be done in both directions, with DFOS interrogators connected at the opposite end, by using different wavelength channels for each DFOS interrogator

### Case I Monitoring the Whole Fiber Span

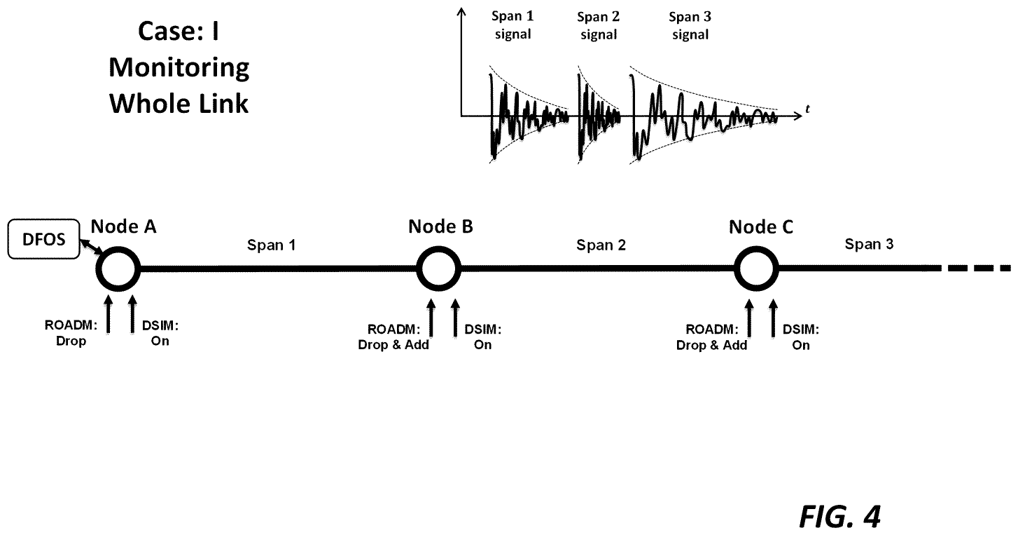

FIG. 4 is a schematic diagram showing an illustrative ROADM and DSIM confirmation for monitoring entire optical links in which Drop DEMUX WSS set to drop DFOS channel, ADD MUX WSS set to add DFOS channel, ON DSIM EDFA turned on, according to aspects of the present invention.

Shown in FIG. 4, when the whole fiber links need to be monitored, all the DSIM needs to be turned on. At all the intermediate ROADM nodes, the DFOS channel is dropped, combined with DFOS signal from the local DSIM, and then added back to WDM transmission in the east-to-west direction. At the initial node where the DFOS interrogator is connected, the DFOS signal is dropped by the ROADM to the interrogator for processing. As all the fiber spans need to be monitored, the total frame length for the DFOS (repetition rate at which each interrogation sequence is sent) needs to satisfy:

$${T}_{frame} \geq 2 \frac{{n}_{eff}}{c} {\sum }_{n = 1}^{N} {L}_{n} ,$$

where Lₙ corresponds to fiber length for each individual fiber span

### Case II Monitoring Single Fiber Span

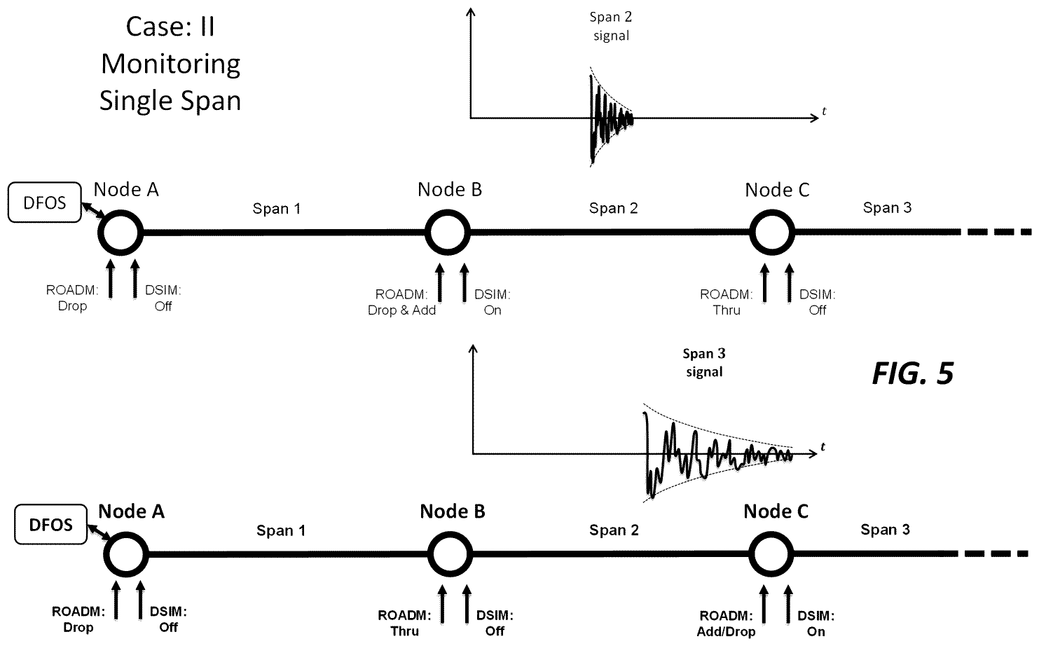

FIG. 5 includes schematic diagrams showing illustrative ROADM and DSIM configurations for monitoring single fiber spans in which Thru: DFOS channel is passed between Mux/Demux WSSs as express through channel, Off: DSIM EDFA turned off, according to aspects of the present disclosure.

Shown in that FIG. 5, when only one fiber span needs to be monitored, the DSIM of the desired span is turned on, while all other DSIMs are turned off. At the ROADM node before the desired fiber span, the DFOS channel is set to drop and add back to WDM transmission in the east-to-west direction after coupling with DFOS signal from desired span. For the rest of the intermediate nodes, the DFOS channel should be set as express through channels (direct connection between Mux and Demux WSS).

At the initial node where the DFOS interrogator is connected, the DFOS signal is dropped by the ROADM to the interrogator for processing. Note that at the intermediate nodes where DFOS monitoring is not needed, it is sufficient to set either the DSIM off or the ROADM in thru. Therefore, if an operator wants to keep ROADM settings constant during dynamic segment monitoring, it is possible to just control the DSIM, or vice versa.

### Case III: Monitoring Segment Containing Multiple Fiber Spans

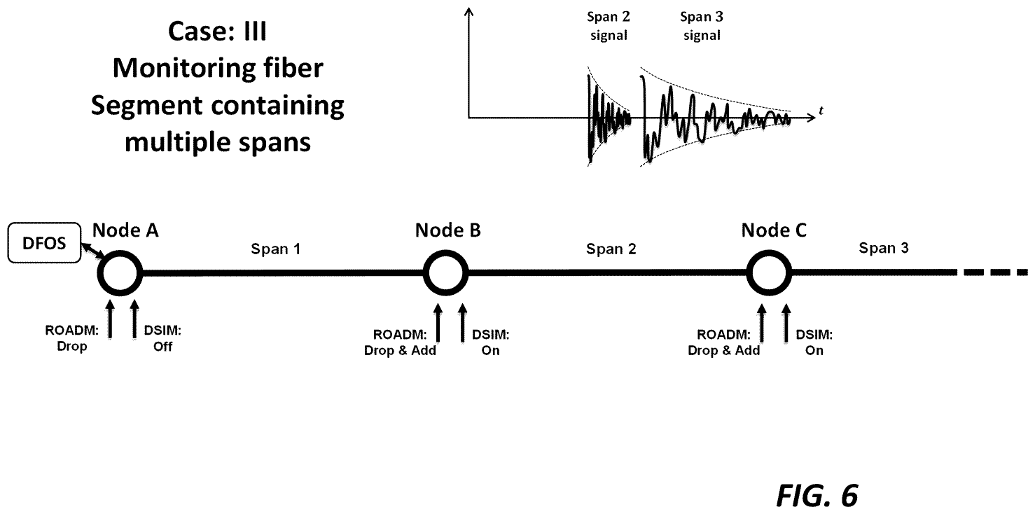

FIG. 6 is a schematic diagram showing illustrative ROADM and DSIM configuration for monitoring segments containing multiple spans according to aspects of the present invention.

Shown in FIG. 6, when monitoring a segment which contains multiple fiber spans, the DSIMs located at the fiber spans within the segment will be turned on, and the ROADM nodes connected to these DSIMs will be set to add and drop the DFOS channel. For all the other intermediate nodes not being monitored, either the DSIMs can be set off, or the ROADMs set to express-thru mode for the DFOS, or both can be set. The ROADM configuration at the initial node where the DFOS interrogator is connected remains unchanged as the DFOS signal is dropped for processing. Note the segment can be as short as 1 fiber span (Case II) or as long as the whole link (Case I). It is also possible for our scheme to monitor multiple segments within the link that are not connected together

### Case IV: Sampling Rate Adjustment for Dynamic Segmented DFOS Monitoring

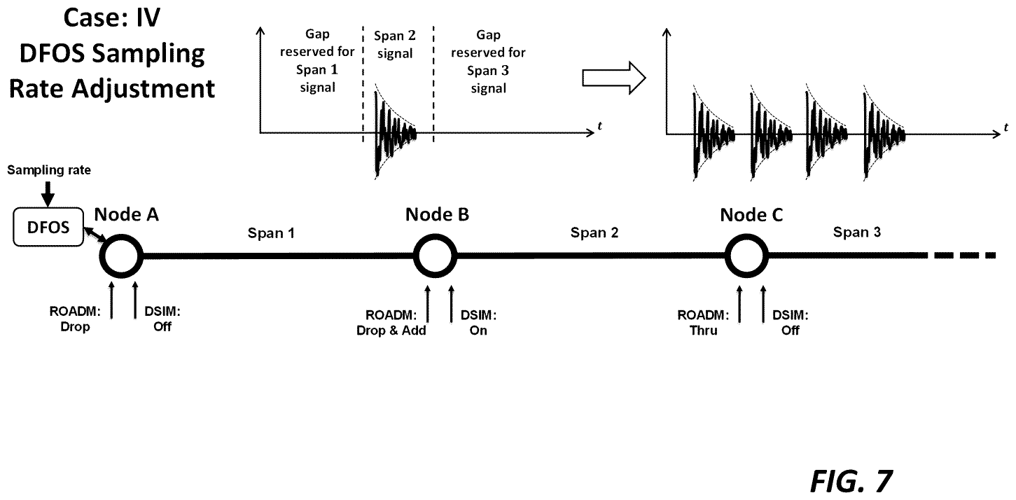

FIG. 7 is a schematic diagram showing illustrative DFOS sampling adjustment for monitoring the fiber segments with shorter fiber lengths according to aspects of the present disclosure.

As will be appreciated by those skilled in the art, one of the many features of our inventive scheme according to aspects of the present disclosure is that it allows adjustment of DFOS sampling rate when looking at specific shorter segments within the fiber link. As shown in FIG. 7, when the system is configured to only monitor one fiber segment, there will be time gaps within the collected DFOS signal if T_{frame} is set to

$${T}_{frame} \geq 2 \frac{{n}_{eff}}{c} {\sum }_{n = 1}^{N} {L}_{n} .$$

This is because the DFOS signal from the spans not monitored are blocked and not being collected. Therefore it is feasible to increase the repetition rate of the DFOS interrogator so the DFOS signal from the desired segment can be collected more frequently by taking advantage of the time gap left open. In this case,

$${T}_{frame} \geq 2 \frac{{n}_{eff}}{c} {\sum }_{n = k + 1}^{k + M} {L}_{n} ,$$

where a total of M fiber spans is monitored within the segment with the k+1 being the first span index. With increased repetition rate, the DFOS signal from the desired segment can be sampled faster and can have improved sensing performance. Higher frequency contents can be monitored without aliasing; SNR can be raised as well because higher frequency noise are not being folded; spatial resolution can also be increased due to reduced frame length.

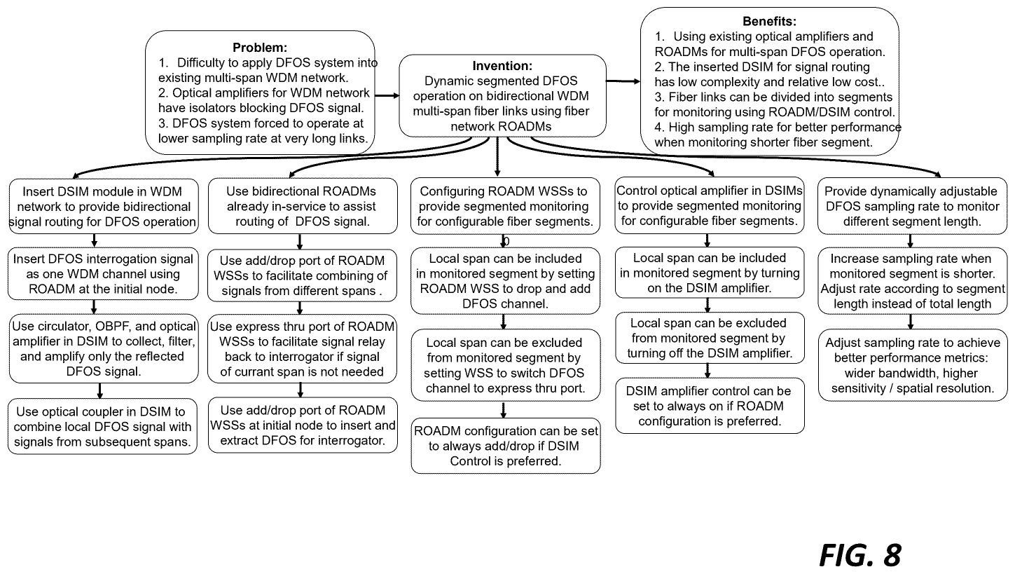

FIG. 8 is a block diagram showing illustrative features of systems and methods according to aspects of the present disclosure.

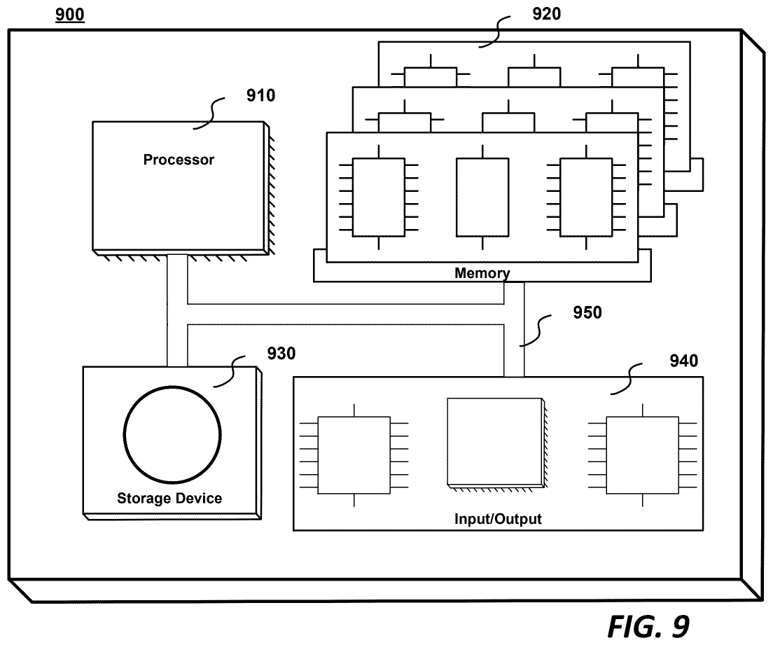

FIG. 9 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 900 as stored program control instructions.

Computer system 900 includes processor 910, memory 920, storage device 930, and input/output structure 940. One or more input/output devices may include a display 945. One or more busses 950 typically interconnect the components, 910, 920, 930, and 940. Processor 910 may be a single or multi core. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

### Field Trial of Illustrative Configuration

### Field Trial Architecture

We evaluated our inventive concept of “synergistic fiber sensing” for long-haul DWDM networks having a repeater node architecture that combines DAS with forward-phase sensing to achieve a synergistic fiber sensing system. As will be understood and appreciated by those skilled in the art, the forward-phase method is used to detect vibration anomalies and to coarsely localize its position within a fiber span. Then, a segmented DAS is used to refine the position estimate and measure its waveform more precisely. We demonstrated our synergistic scheme on a test bed comprising lab fiber spools and field fibers and show that our scheme can detect and monitor field construction while supporting simultaneous 17.2-Tb/s data transmission, validated using a real-time 400G DP-16QAM transponder.

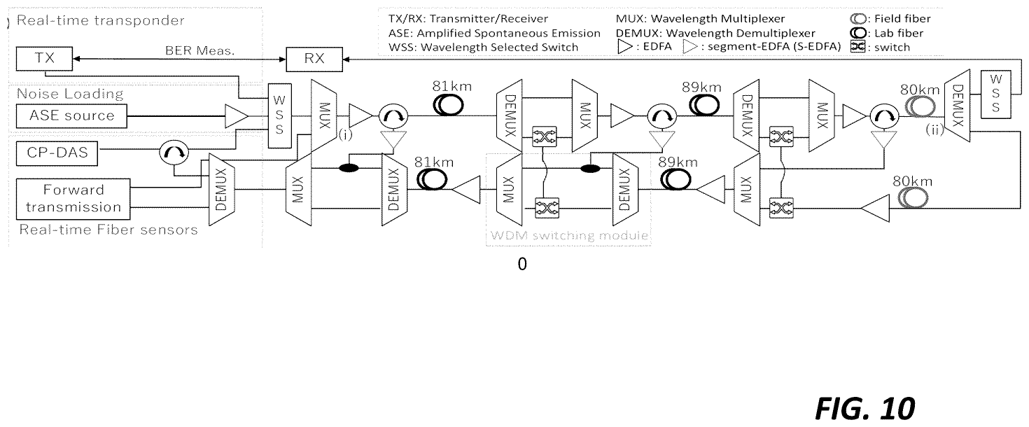

FIG. 10 is a schematic diagram showing an illustrative experimental arrangement for systems and methods according to aspects of the present disclosure.

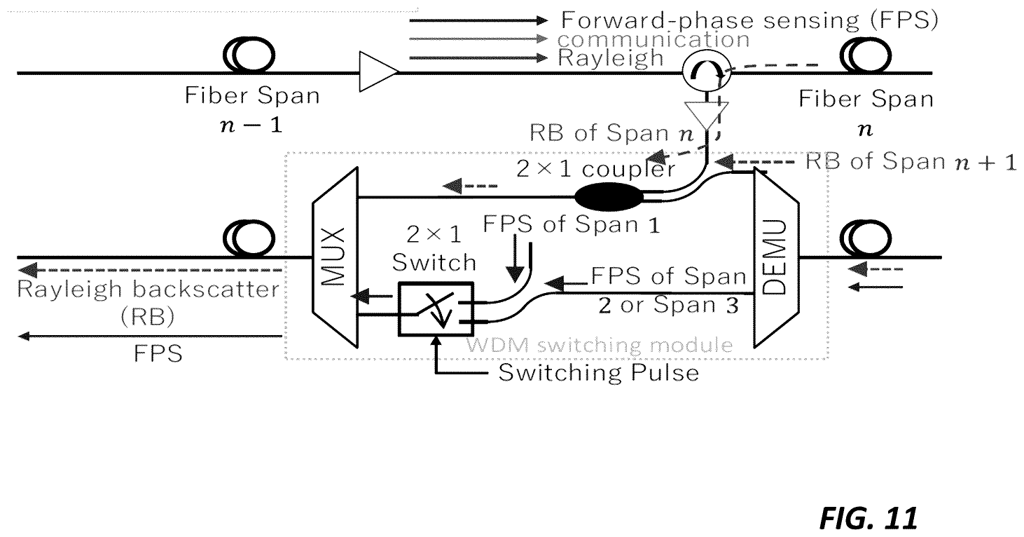

FIG. 11 is a schematic diagram showing an illustrative experimental segment sensing scheme with WDM switching module according to aspects of the present disclosure.

The experimental setup is shown in FIG. 10 and includes two sensing transponders based on chirped-pulse DAS (CP-DAS) and the forward-phase sensing (FPS). The CP-DAS system is centered at 193.400 THz. The probe signal has 40 MHz bandwidth, and 50 us duration, with raised-cosine amplitude rolloff to reduce nonlinear interference on co-propagating telecom channels. The FPS system is centered at 191.400 THz, and the CW probe can be looped back after any fiber span and re-transmitted to the lab using the upstream fiber, where the phase accumulated during transmission is recovered using self-coherent detection.

For data transmission, we use a real-time 64-Gbaud DP-16QAM coherent transponder with a net data rate of 400 Gb/s. The co-propagation of 43 dense wavelength-division multiplexed (DWDM) channels from 191.825 THz to 196.075 THz is emulated with amplified spontaneous emission (ASE) noise loading. A wavelength-selective switch (WSS) combines the noise loading channels, the 400G channel under test (CUT) and the two probe signals from the sensing transponders and flattens the spectrum (FIG. 1(i)).

The transmission link comprises of three fiber pairs. The first two pairs are lab spools: Span 1 are 80 km of ultra-low-loss fibers exhibiting span losses of ˜14 dB; Span 2 are 89 km of SMF-28 with ˜18 dB loss. The third span is 79-km field fiber from a commercial carrier loop. The launch powers to the three spans in the downstream direction were 17, 19 and 20 dBm, respectively. The CUT and CW FPS probes had powers of +3 dBm and −10 dBm at launch in Span 3, while the peak power of the CP-DAS probe was +6.5 dBm. At the output of Span 3, a WSS selects the CUT, and allow measurement of pre- and post-forward error correction (FEC) bit-error rates (BER) by the real-time 400G transponder at a frequency granularity of 100 GHz.

Segmented sensing shown in FIG. 11 is enabled by the node architecture shown in FIG. 10. In the downstream direction, a wavelength multiplexer and demultiplexer (MUX/DEMUX) split off the 191.400 THz CW FPS probe from the rest of the signal, and a 1×2 switch allows the probe to either continue propagation, or be looped back using the upstream link. By comparing the accumulated phases after n−1 spans and after n spans, vibration anomaly can be detected and localized to Span n, where it is examined further using CP-DAS. The Rayleigh backscatter (RB) of each downstream span is passed by the circulator to a segmented amplifier (S-EDFA), which can be turned on/off remotely by a centralized controller. The pair of MUX/DEMUX in the upstream link separates the RB from the CW forward-sensing probe. A 2×1 coupler combines the RB of the current span with the RB of the spans further downstream from the sensing transponder. As the upstream and downstream fibers are usually in the same cable and are of equal length, the RB of different spans do not overlap in time. It is possible to monitor the entire link by turning on all the S-EDFAs and setting the repetition period (1/Rₚ) of the CP-DAS longer than the round-trip propagation delay of the full link. However, the variance of the recovered phase due to additive white Gaussian noise (AWGN) is inversely proportional to Rₚ. A slow repetition rate leads to worse measurand resolution. Our node architecture allows only the span of interest (SUT) to be probed by turning off all the S-EDFAs except for the SUT. Thus, the repetition period only needs to exceed the round-trip delay of the SUT. In addition, as the S-EDFAs of unmonitored spans are turned off, there is less accumulation of ASE noise. Segmented DAS thus achieves higher phase SNR and improved measurand resolution compared with monitoring the whole link. Note that the MUX/DEMUX in FIG. 10 can be replaced with WSSs inside reconfigurable optical add-drop multiplexers (ROADMs) in practical deployment.

### Field Trial Architecture

Experimental results using the FPS sensing method were obtained and the results show phase power spectral density (PSD) measured in the presence of heavy construction at ˜3 km from the start of the field fiber (˜172 km from the CP-DAS transponder), compared with a reference measurement taken during nighttime. It is observed that the PSD of heavy construction is above the nighttime ambient below 50 Hz. FIG. 2(b) shows time-domain waveforms with low-pass filtering below 50 Hz for construction, nighttime, and when the CW signal is looped back after Span 2 and after Span 1. Impulsive phase changes arising from construction can be clearly observed.

The cause of the phase anomaly was identified by field inspection as excavating machines digging within 5 m of the cable. With the forward-phase method successfully localizing the event to Span 3, we switched on the CP-DAS. We determined a power profile of the coherent OTDR measured by the CP-DAS when the S-EDFAs were switched to probe Spans 1 to 3 individually. The probe repetition rate was Rₚ=1145 Hz, allowing an interrogation range (Lᵢₙₜ) of 89 km sufficient to cover Span 2. As the frame trigger for the CP-DAS receiver is synchronized with the start of each generated chirped pulse, the OTDR received when probing Span 2 will be circularly shifted by the round-trip delay of Span 1 whose length is L₁=80 km. Therefore, Span 2's OTDR begins at L₁ mod Lᵢₙₜ=89 km, and ends at (L₁+L₂) mod Lᵢₙₜ=89 km. Similarly, Span 3's OTDR is circularly shifted by the round-trip delay of Spans 1 and 2, and begins at 89 km and ends at (L₁+L₂+L₃) mod Lᵢₙₜ=72 km. To demonstrate improved noise performance, we compared the phase PSD at high frequencies for Span 2 for Rₚ=1145 Hz, and when it was set to Rₚ=580 Hz to monitor both Spans 2 and 3 simultaneously. The phase PSDs measured were 1.6×10⁻⁴ rad²/Hz and 3.5×10⁻⁴ rad²/Hz, respectively, resulting in measurand resolutions of 146 and 214 pe/VHz at a gauge length of 19.2 m. FIG. 2(d) shows a 5-minute waterfall plot recorded by the CP-DAS for the field fiber, with the enlarged view showing the construction at 3.06 km from the start of the field fiber. Long-term measurements further enabled frequency-domain discrimination of different types of machinery used. It was observed that machine-induced vibration has higher frequencies at startup, followed by decay to a lower value during stable operation.

At this point, those skilled in the art will understand and appreciate that while we have presented our inventive concepts and description using specific examples, our invention is not so limited. Accordingly, the scope of our invention should be considered in view of the following claims.

1. A method of operating a distributed fiber optic sensing (DFOS) system over multiple spans of optical fiber of a wavelength division multiplexed (WDM) optical network having a plurality of nodes optically connected to one another by multiple spans of optical fiber, the method comprising:
optically connecting the DFOS system to a first node of the plurality of nodes of the WDM optical network; and
operating the DFOS to optically interrogate one or more of the multiple spans of optical fiber;
wherein the number of spans of the multiple spans of optical fiber that are optically interrogated is determined by a dynamic configuration of one or more reconfigurable optical add/drop multiplexers (ROADMs) in optical communication with the plurality of the multiple spans of optical fiber.

2. The method of claim 1 wherein each ROADM is a bidirectional ROADM and configured to route the DFOS signals through the multiple spans of optical fiber of the WDM optical network. configured to use its ADD/DROP port to combine DFOS signals from multiple spans of optical fiber of the WDM optical network.

3. The method of claim 2 wherein each ROADM is configured to use its ADD/DROP port to combine DFOS signals from multiple spans of optical fiber of the WDM optical network.

4. The method of claim 3 wherein each ROADM is configured to use its express THRU port to relay DOFS backscattered signals back to a DFOS integrator.

5. The method of claim 4 wherein an ADD/DROP port of a ROADM positioned at an initial node of the WDM optical network is configured to insert and extract DFOS signals for interrogation and analysis.

6. The method of claim 5 wherein each node of the WDM optical network includes a distributed sensing interface module (DSIM), the DSIM configured to collect reflected interrogation signals in one direction.

7. The method of claim 6 wherein each individual DSIM is configured to route collected reflected interrogation signals to an ADD port of a ROADM co-located in a same node as the individual DSIM.

8. The method of claim 7 wherein each ROADM and DSIM are configured to limit DFOS interrogation to a desired spans of the multiple spans of optical fiber such that interrogation signal sampling rate is higher and unbound by total, WDM network optical fiber length.
